(19) United States
(12) Patent Application Publication
(10) Pub. No.: US 2007/0157450 A1
(43) Pub. Date: Jul. 12, 2007

(54) Bonding method of metal surfaces

(76) Inventors: Masaya Takahashi, Hitachinaka (JP); Michiya Okada, Mito (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/471,504

(22) Filed: Jun. 21, 2006

(30) Foreign Application Priority Data
Jun. 21, 2005 (JP) 2005-180681

(51) Int. Cl. B23P 25/00

(52) U.S. Cl. 29/458

(57) ABSTRACT

It is an object of the present invention to provide means for forming a good bonded interface with a high process yield in the bonding of metal surfaces. Provided is a method of bonding metal surfaces together, and this method includes the steps of: forming a metal-added layer on one metal surface; forming a metal film, which is made of a metal of the same kind as the other metal surface or a metal capable of being alloyed with the other metal surface, as a layer above the metal-added layer; and performing large deformation, with the other metal surface brought into close contact with the metal film.

### BACKGROUND OF THE INVENTION

1. Field of the Invention

The present invention relates to a bonding method of metal surfaces, and a multi-layered metal tube and a multi-layered metal plate which are obtained by this method.

2. Background Art

The bonding of surfaces of dissimilar metals, such as the bonding of metal plates and the bonding of metal tubes, is required in a very large variety of fields. For example, superconductive-wire metal tubes, DUMET wires and clad metals are products produced by bonding dissimilar metals together. The properties of multiple kinds of metals can be effectively utilized by bonding them.

In bonding surfaces of dissimilar metals together, there has hitherto been know a method which involves bonding metal surfaces together by large deformation after the removal of an oxidized layer by acid cleaning or acetone cleaning. For example, in a case where metal surfaces are to be bonded together in combinations of metals which do not mutually form alloys, such as Cu and Fe, the metal surfaces are bonded together by intermolecular force and, therefore, it is necessary to reduce an oxidized layer which is present on each of the surfaces. For this reason, the oxidized layers are removed by acid cleaning or acetone cleaning and bonding is performed while the oxidized layers are further being rubbed off by large deformation, such as drawing wire. However, the oxidized layers cannot be completely removed even by performing acid cleaning or acetone cleaning, and even when the oxidized layers are removed, new oxidized layers are soon formed again. Thus it is difficult to achieve a strong and good bond. The bonding of active metals having thick oxidized layers is particularly difficult. In order to perform large deformation such as drawing wire, it is desirable to use metals having excellent ductility capable of withstanding large deformation. However, if dissimilar metals having different ductility are subjected to large deformation, only one metal is elongated and, a displacement occurs at a bonded interface, as a result, cracks occur in the bonded interface.

In contrast to this, there has been known a method which involves partially applying a bonding assistant made of a metal capable of forming alloys with both metals which are to be bonded together. For example, in the bonding of Cu and Fe, a Cu—Ni alloy capable of forming alloys with the two metals is used as a bonding assistant. In this method, it is necessary to perform processing by quantifying the application amount of bonding assistant, areas to which a bonding assistant is applied, and the like. However, the application amount necessary for the functioning of a bonding assistant changes depending on the length, surface roughness, material and the like of a metal tube. For this reason, the same application conditions cannot be used every time and it is difficult to adjust application conditions. In bonding between metal tubes, a bonding assistant is entrained into the tubes when the application amount is large and cracks occur at the interface when the application amount is small. In some combinations of metals, a bonding assistant which forms alloys with both metals does not exist and, therefore, combinations of metals capable of being bonded together by this method are limited.

JP Patent Publication (Kokai) No. 4-329221 (1992) describes a method which comprises manufacturing an Nb—Ti alloy superconductive wire by inserting multiple primary material wires, which are Nb—Ti alloy core wires coated with Cu, into a tube made of Cu. In this method, however, oxidized layers of the Nb—Ti alloy core wires are not removed and hence it is difficult to form an effective Cu coating. As a result, it is impossible to form a good bonded interface between the Cu tube and the Nb—Ti alloy core wires.

### SUMMARY OF THE INVENTION

It is an object of the present invention to provide means for forming a good bonded interface with a high process yield in the bonding of metal surfaces.

The present inventors found that a good bond of metal surfaces can be achieved by removing metal oxidized layers while forming a metal-added layer, protecting fresh metal surfaces and assisting bonding by metal films.

That is, the present invention includes the following essential features.
(1) A method of bonding metal surfaces together which comprises the steps of: forming a metal-added layer on one metal surface; forming a metal film, which is made of a metal of the same kind as the other metal surface or a metal capable of being alloyed with the other metal surface, as a layer above the metal-added layer; and performing large deformation, with the other metal surface brought into close contact with the metal film.
(2) A method of bonding an inner metal tube or an inner metal bar and an outer metal tube which comprises the steps of: forming a metal-added layer on an outer circumferential surface of the inner metal tube or the inner metal bar; forming a metal film, which is made of a metal of the same kind as the outer metal tube or a metal capable of being alloyed with the outer metal tube, as a layer outward from the metal-added layer; and performing area-reducing processing.
(3) A method of bonding an inner metal tube or an inner metal bar and an outer metal tube which comprises the steps of: forming a metal-added layer on an inner circumferential surface of the outer metal tube; forming a metal film, which is made of a metal of the same kind as the inner metal tube or the inner metal bar or a metal capable of being alloyed with the inner metal tube or the inner metal bar, as a layer inward from the metal-added layer; and performing area-reducing processing.
(4) A method of bonding metal surfaces of metal plates together which comprises the steps of: forming a metal-added layer on a surface of one metal plate; forming a metal film, which is made of a metal of the same kind as the other metal plate or a metal capable of being alloyed with the other metal plate, as a layer above the metal-added layer; and performing rolling, with the other metal plate brought into close contact with the metal film.
(5) The method according to any one of items (1) to (4), in which the metal-added layer contains a metal selected from the group consisting of Ti, Cr, TiAl, C, Al, V, Fe, Co, Ni, Cu, Zr, Nb, Mo, Ag, Hf, Ta and W.
(6) The method according to any one of items (1) to (5), in which the film thickness of the metal film is 0.01 μm to 100 μm.
(7) The method according to any one of items (1) to (6), in which the metal film is formed under the conditions of 10^{31 1} Pa to 10^{31 10} Pa and 150° C. to 600° C.
(8) A multi-layered metal tube which is obtained by the method according to item (2) or (3), and has a structure in which the inner metal tube or the inner metal bar and the outer metal tube are bonded.
(9) A multi-layered metal tube having a structure in which an inner metal tube or an inner metal bar and an outer metal tube are bonded, which comprises: an inner metal tube or an inner metal bar; a metal-added layer formed on an outer circumferential surface of the inner metal tube or the inner metal bar; a metal film which is formed as a layer outward from the metal-added layer and made of a metal of the same kind as the outer metal tube or a metal capable of being alloyed with the outer metal tube; and an outer metal tube which is bonded to the inner metal tube or the inner metal bar via the metal-added layer and the metal film.
(10) A multi-layered metal tube having a structure in which an inner metal tube or an inner metal bar and an outer metal tube are bonded, which comprises: the outer metal tube; a metal-added layer formed on an inner circumferential surface of the outer metal tube; a metal film which is formed as a layer inward from the metal-added layer and made of a metal of the same kind as the inner metal tube or the inner metal bar or a metal capable of being alloyed with the inner metal tube or the inner metal bar; and the inner metal tube or the inner metal bar which is bonded to the outer metal tube via the metal-added layer and the metal film.
(11) The multi-layered metal tube according to any one of items (8) to (10), in which the metal-added layer contains a metal selected from the group consisting of Ti, Cr, TiAl, C, Al, V, Fe, Co, Ni, Cu, Zr, Nb, Mo, Ag, Hf, Ta and W.
(12) The multi-layered metal tube according to any one of items (8) to (11), in which the film thickness of the metal film is 0.01 μm to 100 μm.
(13) A multi-layered metal plate which is obtained by the method according to item (4) and has a structure in which multiple metal plates are bonded.
(14) A multi-layered metal plate in which multiple metal plates are bonded, which comprises: a metal plate; a metal-added layer formed on a surface of the metal plate; a metal film formed as a layer above the metal-added layer; and an additional metal plate bonded to the metal plate via the metal-added layer and the metal film. The metal film is made of a metal of the same kind as the additional metal plate, which is bonded to the metal plate via the metal-added layer and the metal film, or is made of a metal capable of being alloyed with the additional metal plate.
(15) The multi-layered metal plate according to item (13) or (14), in which the metal-added layer contains a metal selected from the group consisting of Ti, Cr, TiAl, C, Al, V, Fe, Co, Ni, Cu, Zr, Nb, Mo, Ag, Hf, Ta and W.
(16) The multi-layered metal plate according to any one of items (13) to (15), wherein the film thickness of the metal film is 0.01 μm to 100 μm.

According to the present invention, a good bonded interface can be formed with a high process yield in the bonding of metal surfaces. Metal surfaces can be bonded together without being restricted by the kinds and combinations of metals to be bonded.

The present description includes part or all of the contents as disclosed in the description and /or drawing of Japanese Patent Application No. 2005-180681, which is a priority document of the present application.

### BRIEF DESCRIPTION OF THE DRAWINGS

FIG. 1 is a diagram showing the cross section structure of an MgB₂ superconductive wire which was produced in Comparative Example 1-1;

FIG. 2 is a cross section photograph of the MgB₂ superconductive wire made by using a Cu-Fe double metal tube, which was produced in Comparative Example 1-1;

FIG. 3 is a cross section photograph of an MgB₂ superconductive wire made by using a Cu-Nb double metal tube, which was produced in Comparative Example 1-2;

FIG. 4 is a diagram showing the cross section structure of an MgB₂ superconductive wire which was produced in Comparative Example 2-1;

FIG. 5 is a cross section photograph of the MgB₂ superconductive wire made by using a Cu-Fe double metal tube, which was produced in Comparative Example 2-1;

FIG. 6 is a cross section photograph of an MgB₂ superconductive wire which was similarly produced as in Comparative Example 2-1 except that the application amount of a bonging assistance was reduced;

FIG. 7 is a diagram showing the cross section structure of an MgB₂ superconductive wire which was produced in Example 1-1;

FIG. 8 is a cross section photograph of an MgB₂ superconductive wire which was produced in Example 1-1;

FIG. 9 is a diagram showing the cross section structure of an Nb tube on which a Cu film was formed in Example 1-2;

FIG. 10 is a cross section photograph of an MgB₂ superconductive wire which was produced in Example 1-2;

FIG. 11 is a graph showing the result of critical current measurement of a wire rod as to the MgB₂ superconductive wire which was produced in Example 1-2;

FIG. 12 is a diagram showing the cross section structure of an MgB₂ superconductive wire which was produced in Example 2;

FIG. 13 is a cross section photograph of the MgB₂ superconductive wire which was produced in Example 2;

FIG. 14 is a diagram showing the cross section structure of an MgB₂ superconductive wire having a multistage structure, which was produced in Example 3;

FIG. 15 is a diagram showing the cross section structure of an MgB₂ superconductive wire having a triple-tube structure, which was produced in Example 4;

FIG. 16 is a diagram showing the cross section structure of a double metal tube produced in Example 5, the center part of which is a metal bar; and

FIG. 17 is a diagram showing the cross section structure of a double metal plate, which was produced in Example 6.

### DETAILED DESCRIPTION OF THE PREFERRED EMBODIMENTS

The present invention relates to a method of bonding metal surfaces, particularly, metal surfaces of dissimilar metals. A method of the present invention includes: a step of forming a metal-added layer on one metal surface; a step of forming a metal film, which is made of a metal of the same kind as the other metal surface or a metal capable of being alloyed with the other metal surface, as a layer above the metal-added layer; and a step of performing large deformation, with the other metal surface brought into close contact with the metal film.

Metals which enable metal surfaces to be bonded together according to the present invention are not especially limited so long as they do not melt under the conditions for forming a metal-added layer and under the condition for forming a metal film. For example, it is possible to bond metal surfaces with an arbitrary combination of metals selected from the group consisting of Cu, Fe, Nb, Mg, Al, Ti, V, Cr, Mn, Co, Ni, Zn, Zr, Mo, Tc, Ru, Rh, Pd, Ag, Cd, In, Sn, Pt, Au and Pb. In the present invention, alloys are also included in metals. Because in the present invention a bonding assistant capable of being alloyed with metals to be bonded is not used, the present invention is very advantageous in that the kinds of metals to be bonded are not limited. The present invention is especially advantageously used in the bonding of metals that do not allow the formation of good bonded interface therebetween by a conventional method, for example, in the bonding of metal surfaces between metals for which there is no metal capable of being alloyed with both metals (for example, Cu—Nb), the bonding of metal surfaces between metals having different ductility (for example, Cu—Fe), and the bonding of a metal surface to an active metal with a thick oxidized layer (for example, Nb). The present invention is especially preferably used in the bonding of metal surfaces between Cu—Fe and Cu—Nb.

The formation of a metal-added layer can be performed by irradiating a metal surface with metal ions. By irradiating a metal surface with metal ions, a metal oxidized layer is removed and at the same time, the metal ions are introduced into an upper layer of the metal surface and a metal-added layer is formed. Examples of a method of irradiating with metal ions include the sputtering method, the arc ion plating method and the CVD (chemical vapor deposition) method, and the sputtering method is preferably used. Usually, a metal-added layer has such a structure that another metal is embedded in an upper layer of a metal surface. The thickness of a metal-added layer is usually 1 nm to 990 nm. Examples of metal ions which are applied include high-energy metal ions, for example, ions of Ti, Cr, TiAl, C, Al, V, Fe, Co, Ni, Cu, Zr, Nb, Mo, Ag, Hf, Ta and W. Ions of Ti, Cr or TiAl are preferable. High-energy metal ions, which have large particle sizes, can effectively remove a metal oxidized layer. The formation of a metal-added layer may be performed by the irradiation with one kind of metal ions or by the irradiation with multiple kinds of metal ions.

The formation of a metal-added layer is performed by irradiating with metal ions usually under a reduced pressure condition of 10^{31 1} Pa to 10^{31 10} Pa, preferably 10^{31 1} Pa to 10^{31 5} Pa, and usually at a temperature of 100° C. to 600° C., preferably 300° C. to 500° C.

In a method of the present invention, a metal film is formed as a layer above the metal-added layer formed as described above. Because a metal oxidized layer is removed by the above-described step, the formation of a metal film can be effectively performed. A metal film is made of a metal of the same kind as the other metal surface to be bonded or a metal capable of being alloyed with the other metal surface to be bonded. Metals capable of being alloyed with the other metal surface can be appropriately selected by those skilled in the art and examples of a metal capable of being alloyed with Fe and Cu include Cu-Ni alloys.

The formation of a metal film is performed preferably by the dry film forming method. The formation of a metal film is performed usually at a pressure of 10^{31 1} Pa to 10^{31 1O} Pa, preferably at 10^{31 2} Pa to 10^{31 4} Pa and usually at a temperature of 150° C. to 600° C., preferab ly at 300° C. to 500° C. It is preferred that the formation of a metal film be performed after the formation of a metal-added layer, with the reduced presser conditions maintained. This can prevent formation of a new oxidized layer. The film thickness of a metal film is usually 0.01 μm to 100 μm, preferably 0.1 μm to 5 μm.

Examples of the dry film forming method include the microwave CVD (chemical vapor deposition) method, the ECRCVD (electron cyclotron resonance chemical vapor deposition) method, the ICP (inductive coupled plasma) method, the direct current sputtering method, the ECR (electron cyclotron resonance) sputtering method, the ion plating method, the arc ion plating method, the EB (electron beam) deposition method, the resistive heating deposition method, the ionized deposition method, the arc deposition method, and the laser deposition method. The arc ion plating method is preferably used. The use of the dry film forming deposition enables the film thickness of a metal film to be controlled to a desired range. “As a layer above the metal-added layer” means that it includes not only a case where a metal layer is formed directly on the metal-added layer, but also a case where a metal film is formed via another layer which does not hinder bonding. As another layer, a layer for improving adhesion of metal surfaces can be interposed. For example, a Cr layer can be interposed between C and Fe, and a Ti layer can be interposed between Nb and Ta.

It is desirable that solidified molten metal called droplets be present on the surface of a metal film after film formation. Because the droplets provide contact points in bonding metal surfaces together, it is possible to improve contact pressures obtained from large deformation.

By forming a metal film as described above, it is possible to prevent formation of a new oxidized layer after the removal of an oxidized layer. Also, because a metal film is made of a metal of the same kind as the metal to be bonded or a metal capable of being alloyed with the metal to be bonded, a metal film has the function of increasing the adhesiveness of bonding. Furthermore, even when a metal film exfoliates during large deformation, a fresh metal surface is exposed and a metal oxidized layer is not exposed. Therefore, good bonding is not impeded.

Large deformation includes area-reducing processing, rolling and the like, and those who skilled in the art can select a suitable processing according to the shape of a metal to be bonded. A metal may be heated before large deformation.

A metal surface includes not only a flat surface, but also a curved surface. Surfaces having irregularities, such as a stepped surface and a wavy surface, are also included. Any metal surfaces can be bonded by the method of the present invention. Flat surfaces of metal plates can be bonded together and curved surfaces of metal tubes can be bonded together.

Therefore, in one embodiment, the present invention provides a method of bonding an inner metal tube or an inner metal bar and an outer metal tube which includes: a step of forming a metal-added layer on an outer circumferential surface of the inner metal tube or the inner metal bar; a step of forming a metal film, which is made of a metal of the same kind as the outer metal tube or a metal capable of being alloyed with the outer metal tube, as a layer outward from the metal-added layer; and a step of performing area-reducing processing.

The step of forming a metal-added layer and the step of forming a metal film as a layer outward from the metal-added layer are same as described above. As in the foregoing, “as a layer outward from the metal-added layer” means that it includes not only a case where a metal layer is formed directly on the metal-added layer, but also a case where a metal film is formed via another layer which does not hinder bonding. That is, so long as a metal film made of a metal of the same kind as the outer metal tube or a metal capable of being alloyed with the outer metal tube is present just on the inner side of the outer metal tube, another layer, preferably, another layer capable of providing high adhesiveness may be present under the metal film. “Area-reducing processing” usually refers to a processing by which the whole diameter or height of a material is reduced and the density becomes high. Specifically, area-reducing processing includes drawing wire, drawing and extrusion.

The present invention also relates to a multi-layered metal tube which is obtained by the above-described method, and has a structure in which the inner metal tube or the inner metal bar and the outer metal tube are bonded. A multi-layered metal tube of the present invention has a structure in which a metal bar and a metal tube or multiple metal tubes are bonded at their outer and inner circumferential surfaces. A multi-layered metal tube includes not only a double metal tube, but also a triple metal tube, a quadruple metal tube and the like. In the present invention, a multi-layered metal tube includes those having a metal bar in the center and those having a tube hole filled with metal. So long as a multi-layered metal tube has at least one metal bonded surface bonded by the method of the present invention, this multi-layered metal tube is included in a multi-layered metal tube of the present invention. Similarly also in a case where a triple metal tube and a quadruple metal tube are manufactured, after the formation of a metal-added film on an inner metal tube, a metal film of a metal of the same kind as a metal tube to be bonded outside or a metal capable of being alloyed with this metal tube is formed and area-reducing processing is performed.

In the present invention, a multi-layered metal tube having a structure in which an inner metal tube or an inner metal bar and an outer metal tube are bonded, comprises: an inner metal tube or an inner metal bar; a metal-added layer formed on an outer circumferential surface of the inner metal tube or the inner metal bar; a metal film which is formed as a layer outward from the metal-added layer and made of a metal of the same kind as the outer metal tube or a metal capable of being alloyed with the outer metal tube; and an outer metal tube which is bonded to the inner metal tube or the inner metal bar via the metal-added layer and the metal film.

In a multi-layered metal tube of the present invention, another layer which does not hinder the bonding, for example, a highly adhesive layer may be present between the metal-added layer and the metal film.

According to the present invention, since it is easy to form a metal film of the same kind as the outer metal tube on the inner metal tube or the inner metal bar after the oxidized layer of the inner metal tube or inner metal bar is removed, no problems occur due to the combinations of metals, even when a metal which can be alloyed with both of the inner metal tube or the inner metal bar and the outer metal tube does not exist. Also, a metal film is evenly formed with an almost equal film thickness on the outer side of the inner metal tube or the inner metal bar, an optimum application amount can be easily controlled. Therefore, the phenomenon that the formed metal film is entrained into the interior of the inner metal tube during area-reducing processing does not occur.

It is also possible to manufacture a multi-layered metal tube by forming the metal-added layer and the metal film on an inner circumferential surface of the outer metal tube. Therefore, in one embodiment, the present invention relates also to a method of bonding an inner metal tube or an inner metal bar and an outer metal tube which includes: a step of forming a metal-added layer on an inner circumferential surface of the outer metal tube; a step of forming a metal film, which is made of a metal of the same kind as the inner metal tube or the inner metal bar or a metal capable of being alloyed with the inner metal tube or the inner metal bar, as a layer inward from the metal-added layer; and a step of performing area-reducing processing.

A multi-layered metal tube obtained by this method includes an outer metal tube; a metal-added layer formed on an inner circumferential surface of the outer metal tube; a metal film which is formed as a layer inward from the metal-added layer and made of a metal of the same kind as the inner metal tube or the inner metal bar or a metal capable of being alloyed with the inner metal tube or the inner metal bar; and an inner metal tube or an inner metal bar which is bonded to the outer metal tube via the metal-added layer and the metal film.

The outside diameter, inside diameter, length and the like of metal tubes which constitutes a multi-layered metal tube of the present invention are not especially limited so long as they permit area-reducing processing, and can be appropriately determined a person skilled in the art.

A multi-layered metal tube obtained by the present invention is useful for the manufacture of a composite superconductive wire. In the manufacture of a composite superconductive wire, for example, it is possible to use a double metal tube in which the outer metal tube is a Cu tube and the inner metal tube is an Fe tube or an Nb tube, and in this case, it is preferred that a Cu film be formed as the metal film. For example, by filling the interior of a multi-layered metal tube of the present invention with an Mg powder and a B powder, it is possible to manufacture an MgB₂ superconductive wire. In an MgB₂ superconductive wire, the presence of an oxidized layer reduces the superconductive performance and, therefore, it is important that an oxidized layer is not present at an interface between metal tubes. Therefore, an excellent MgB₂ superconductive wire can be manufactured according to the present invention. The present invention is also advantageous in that a composite material in which metal tubes are goodly bonded together can be manufactured without the limitation of the kinds and combinations of metal tubes.

The present invention is similarly applicable also to an Nb₃Sn superconductive wire rod and an Nb₃A1 superconductive wire in which a Cu—Nb double metal tube is used. Also, the present invention can be used in increasing the adhesion between an NbTi filament and a stabilized Cu or Cu—Ni alloy in an NbTi superconductive wire. Furthermore, the present invention is also applicable to the production of superconductive materials as well as functional materials in which a general metal powder is filled.

In another embodiment, the present invention relates to a method of bonding metal surfaces of metal plates together. This method includes: a step of forming a metal-added layer on a surface of one metal plate; a step of forming a metal film, which is made of a metal of the same kind as the other metal plate or a metal capable of being alloyed with the other metal plate, as a layer above the metal-added layer; and a step of performing rolling, with the other metal plate brought into close contact with the metal film.

The step of forming a metal-added layer and the step of forming a metal film as a layer above the metal-added layer are same as described above. As in the foregoing, “as a layer above the metal-added layer” means that it includes not only a case where a metal film is formed directly on the metal-added layer, but also a case where a metal film is formed via another layer which does not hinder bonding.

The shape of a metal plate is not especially limited so long as it permits rolling. Although a flat plate, a curved plate and those having irregularities may be used. A flat plate is preferably used.

Rolling is a processing by which a metal material is subjected to rotating rolls to perform shaping by reducing thickness and sectional area. Examples of rolling include plate rolling, hot sheet rolling, cold sheet rolling and section rolling.

The present invention also relates to a multi-layered metal plate in which multiple metal plates are bonded, which is obtained by the above-described method. A multi-layered metal plate of the present invention comprises a structure in which at least two metal plates are bonded. Therefore, a multi-layered metal plate of the present invention includes not only a double metal plate, but also a triple metal plate, a quadruple metal plate and the like. So long as a multi-layered metal plate comprises at least one metal bonded surface bonded by the method of the present invention, this multi-layered metal plate is included in a multi-layered metal plate of the present invention.

A multi-layered metal plate of the present invention in which multiple metal plates are bonded comprises: a metal plate; a metal-added layer formed on a surface of the metal plate; a metal film formed as a layer above the metal-added layer; and an additional metal plate bonded to the metal plate via the metal-added layer and the metal film. The metal film is made of a metal of the same kind as the additional metal plate, which is bonded to the metal plate via the metal-added layer and the metal film, or a metal capable of being alloyed with the additional metal plate.

In a multi-layered metal plate of the present invention, another layer which does not hinder bonding, for example, a high-adhesion layer may be present between the metal-added layer and the metal film.

### Example

### Comparative Example 1:

Production of MgB₂ Superconductive Wire by performing only Acid Cleaning or Acetone Cleaning and Bonding by large deformation

### Comparative Example 1-1

Case of Cu—Fe Double Metal Tube

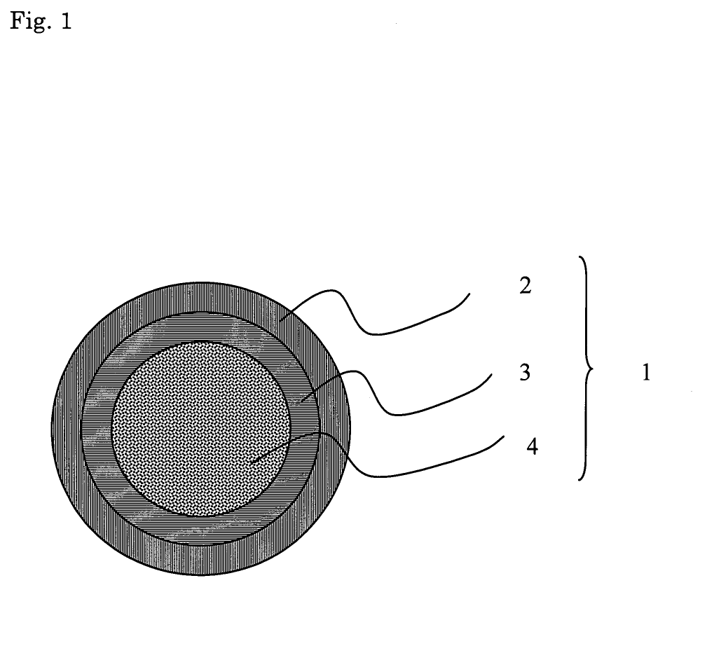

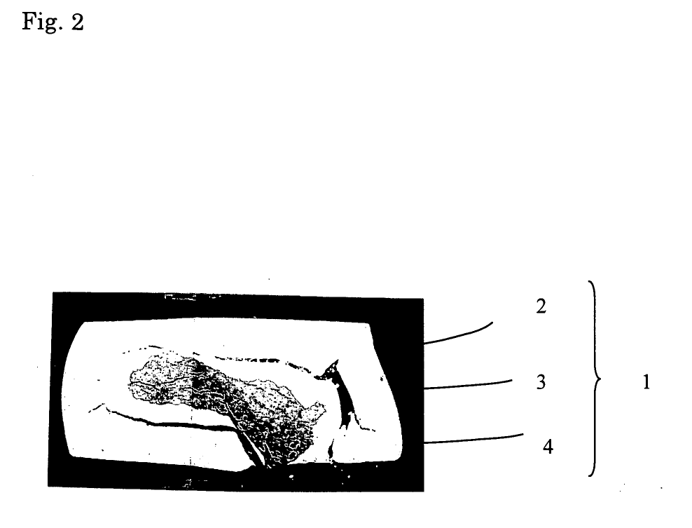

FIG. 1 shows the cross section structure of an MgB₂ superconductive wire which was produced. The MgB₂ superconductive wire 1 was constituted of an outer metal tube 2, an inner metal tube 3, and an MgB₂ core portion 4. In this case, the outer metal tube 2 was a Cu tube and the inner metal tube 3 was an Fe tube. An Mg power and a B powder, which had been mixed in a ball mill, were filled in the Fe tube in Ar gas atmosphere, the Fe tube was covered with the Cu tube, and drawing wire was preformed by using a draw bench. FIG. 2 shows a cross section photograph of the MgB₂ superconductive wire made by using a Cu—Fe double metal tube, which was produced in Comparative Example 1-1. From the result of an observation of the cross section surface of the MgB₂ superconductive wire, it is apparent that cracks occurred at an interface between Cu and Fe and hence a good wire rod was not produced.

It might be thought that because Cu has a higher ductility, whereas Fe has a lower ductility, only Cu was elongated and the bonded interface displaces during large deformation, with the result that the cracks occurred at the bonded interface. The foregoing suggests that a good bonded interface cannot be formed by bonding of metal surfaces having different ductility when using a conventional method.

### Comparative Example 1-2

Case of Cu—Nb Double Metal Tube

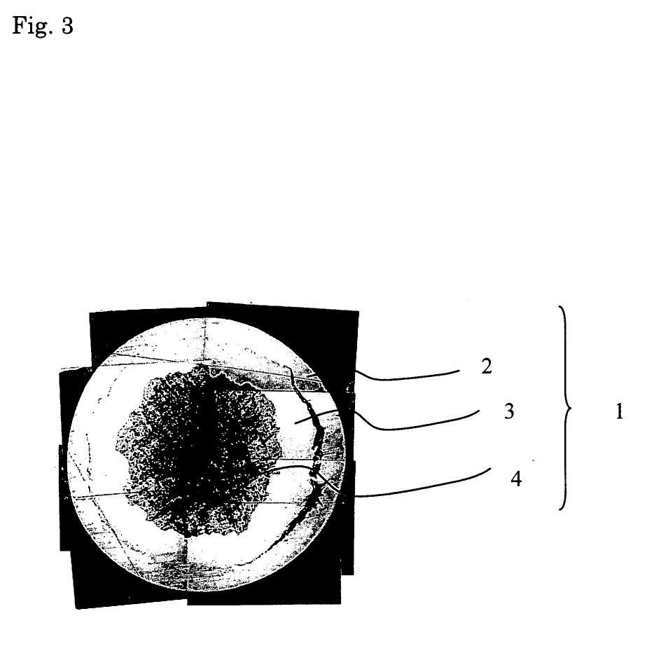

The cross section structure was the same as in FIG. 1. In this case, an outer metal tube 2 was a Cu tube and an inner metal tube 3 was an Nb tube. An Mg power and a B powder, which had been mixed in a ball mill, were filled in the Nb tube in Ar gas atmosphere, the Nb tube was covered with the Cu tube, and drawing wire was preformed by using a draw bench. FIG. 3 shows a cross section photograph of an MgB₂ superconductive wire made by using a Cu—Nb double metal tube, which was produced in Comparative Example 1-2. From the result of an observation of the cross section surface of the MgB₂ superconductive wire, it is apparent that defective bonding occurred at an interface between Cu and Nb and hence a good wire rod was not produced.

It might be thought that although both Cu and Nb have high ductility, an oxidized layer was very thick because Nb is an active metal, and that the oxidized layer could not be completely removed during drawing wire. As a result, defective bonding occurred in places where the oxidized layer remained. Therefore, it was shown that, even when metals having excellent ductility are bonded together, a good bonded interface cannot be formed with a conventional method in the bonding using an active metal.

### Comparative Example 2:

Production of MgB₂ Superconductive Wire by using Bonding Assistant capable of forming alloys with both metals

### Comparative Example 2-1

Case of Cu—Fe Double Metal Tube

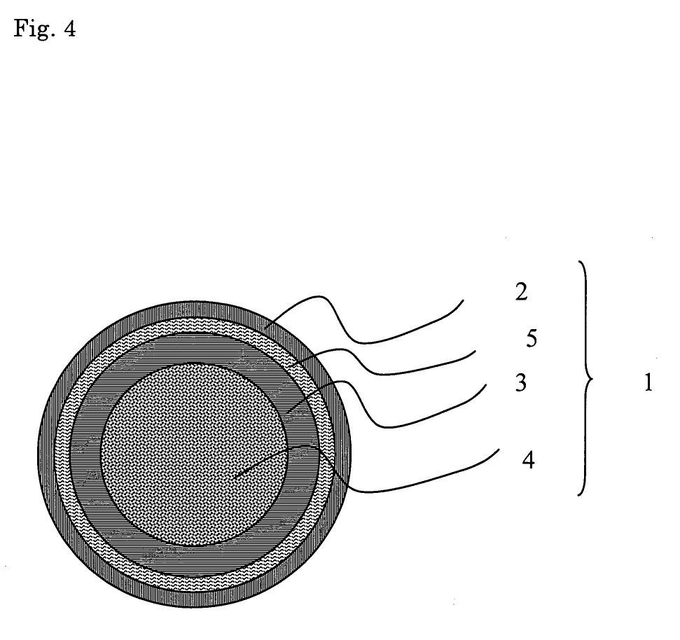

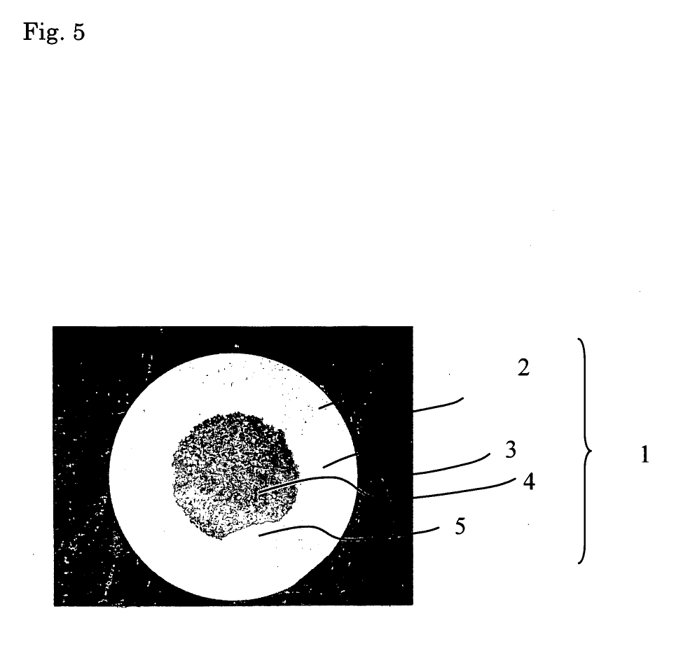

FIG. 4 shows the cross section structure of an MgB₂ superconductive wire which was produced. The MgB₂ superconductive wire 1 was constituted of an outer metal tube 2, a bonding assistant layer 5, an inner metal tube 3, and an MgB₂ core portion 4. In this case, the outer metal tube 2 was a Cu tube, the inner metal tube 3 was an Fe tube, and the bonding assistant layer 5 was a Cu—Ni alloy. An Mg power and a B powder, which had been mixed in a ball mill, were filled in the Fe tube in Ar gas atmosphere, the Cu—Ni alloy was applied to the outer surface of the Fe tube, the Fe tube was then covered with the Cu tube, and drawing wire was preformed by using a draw bench. FIG. 5 shows a cross section photograph of the MgB₂ superconductive wire made by using a Cu—Fe double metal tube, which was produced in Comparative Example 2-1. From the result of an observation of the cross section surface of the MgB₂ superconductive wire, it is apparent that the bonded interface between Cu and Fe was good, however, Cu—Ni alloy that forms the bonding assistant layer 5 penetrates into the MgB₂ core portion 4.

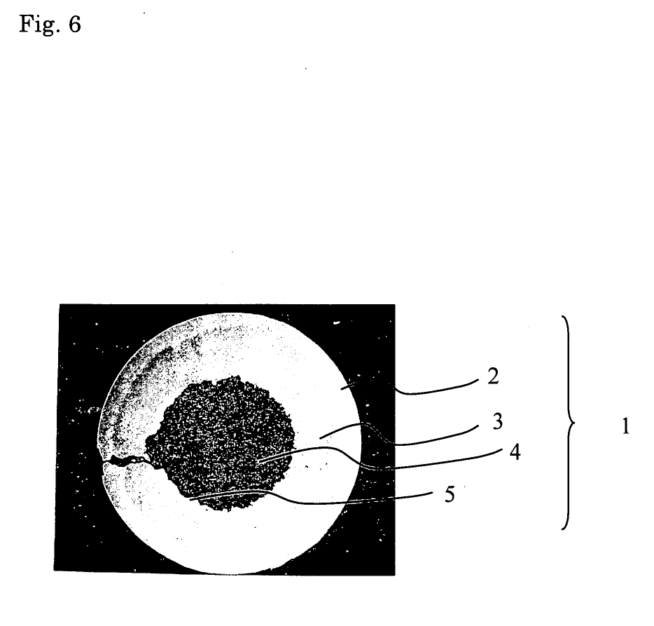

It might be thought that this is because the application amount of the Cu—Ni alloy, which is the bonding assistant, was too large. FIG. 6 is a cross section photograph of an MgB₂ superconductive wire which was similarly produced by reducing the application amount of a bonging assistant. Cracks occurred partially at the interface due to the reduction of the application amount. From the foregoing it was shown that an MgB₂ superconductive wire having a good bonded interface cannot be produced even when a bonding assistant is used.

### Example 1:

Production of MgB₂ superconductive wire by metal bonding via metal-added layer and metal film

### Example 1-1

Case of Cu—Fe Double Metal Tube

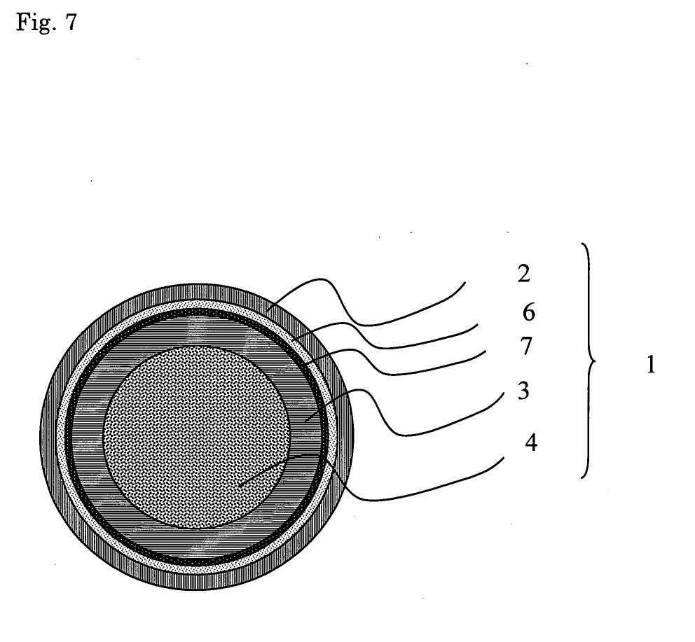

FIG. 7 shows the cross section structure of an MgB₂ superconductive wire produced in Example 1-1. The MgB₂ superconductive wire 1 was constituted of an outer metal tube 2, a metal film 6, a metal-added layer 7, an inner metal tube 3, and an MgB₂ core portion 4. In this case, the outer metal tube 2 was a Cu tube, the metal film 6 was a Cu film, the metal-added layer 7 was a Ti-added layer, and the inner metal tube 3 was an Fe tube.

The Fe tube was sealed in a chamber in a high-vacuum condition of about 10^{31 3} Pa or so and heated to 500° C. After that, the Fe tube was irradiated with Ti ions to remove a surface oxidized layer of the Fe tube, and the metal-added layer was formed on the surface of the Fe tube. The metal-added layer was formed by implanting Ti ions into an outermost portion of the Fe tube. Next, the Cu film was formed in a thickness of 3 μm on the Fe tube, with the degree of vacuum and the temperature kept.

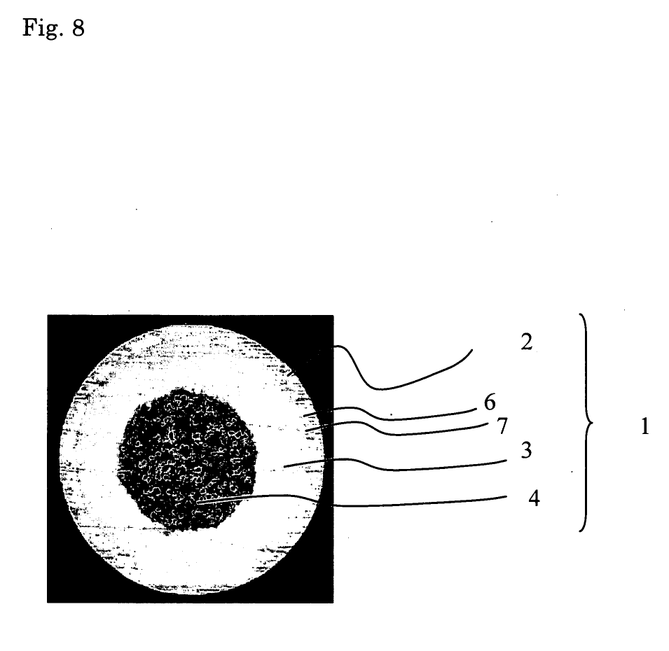

Next, an Mg power and a B powder, which had been mixed in a ball mill, were filled in the Fe tube, on which Cu had been formed, in an Ar gas atmosphere. The Fe tube was then covered with the Cu tube, and drawing wire was preformed by using a draw bench. FIG. 8 shows a cross section photograph of an MgB₂ superconductive wire produced in this example. As a result of an observation of the cross section surface of the MgB₂ superconductive wire, it is apparent that the bond at an interface between Cu and Fe is uniform and good.

### Example 1-2

Case of Cu—Nb Double Metal Tube

The cross section structure is the same as in FIG. 7. In this case, an outer metal tube 2 was a Cu tube, a metal film 6 was a Cu film, a metal-added layer 7 was a Ti-added layer, and an inner metal tube 3 was an Nb tube. Initial sizes of each of the metal tubes in an MgB₂ superconductive wire made in this example using a Cu—Nb double metal tube are as follows.

Cu tube: Outside diameter 18 mm, inside diameter 16 mm, length 500 mm

Nb tube: Outside diameter 15 mm, inside diameter 11 mm, length 500 mm

First, by irradiating an outer circumferential surface of the Nb tube with Ti ions by using an ion implanting device, an oxidized layer was removed and a Ti metal-added layer was formed on the outer circumferential surface of the Nb tube. Incidentally, the atmosphere in a chamber during film formation was held at 500° C. and 3.0 ×1O³ Pa.

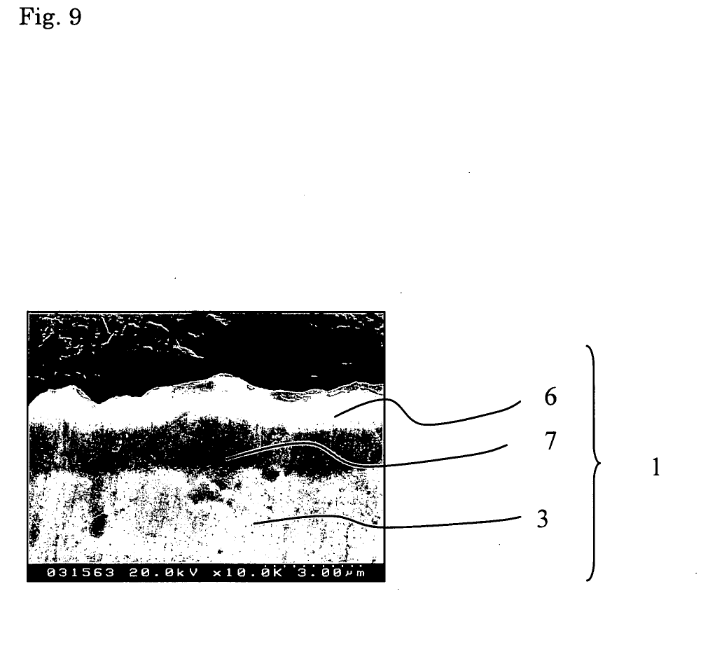

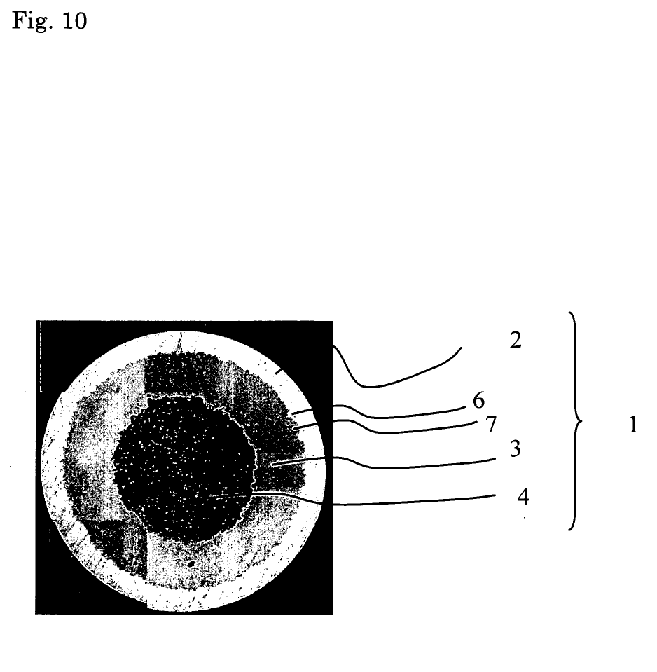

Next, a Cu film was formed on the Nb tube, with the Nb tube kept in the chamber. The atmosphere conditions during the film formation were the same as during the Ti ion irradiation. The film thickness of the Cu film was 3 μm. FIG. 9 shows the cross section structure of the Nb tube on which the Cu film was formed. From the figure it is apparent that the Cu film was formed on the Nb tube, with the Ti of the metal-added layer interposed. Next, in a globe box sealed with Ar gas, an Mg powder and a B powder, which had been mixed in a ball mill, were filled in this Nb tube on which the Cu film had been formed. Subsequently, a periphery of the Nb tube in which the Mg powder and the B powder had been filled and on which the Cu film had been formed was covered with the Cu tube, and drawing wire was performed by using a draw bench. The drawing wire was continued until the overall diameter became φ0.5 mm. FIG. 10 shows a cross section photograph of an MgB₂ superconductive wire after the drawing wire. From this photograph it is apparent that a good bonded interface was formed.

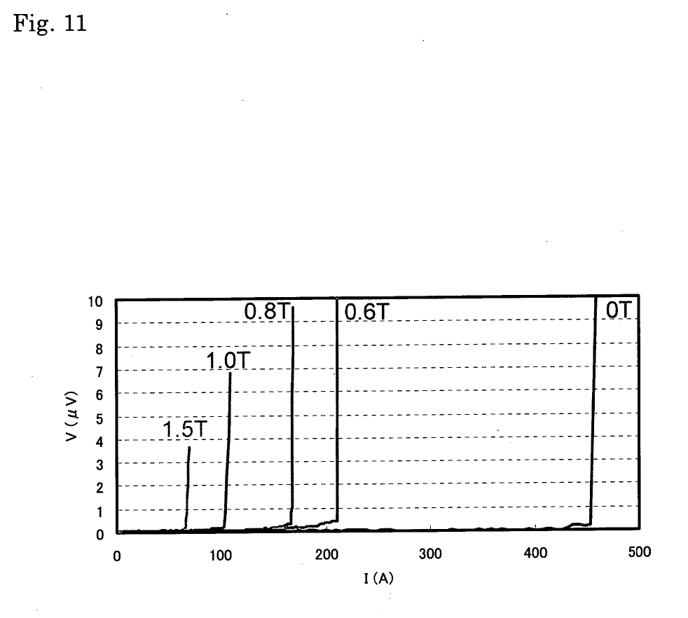

A critical current of a wire rod was measured as to the MgB₂ superconductive wire produced as described above. The measurement was made by using the general direct-current four-terminal method while immersing the whole sample in liquid helium. FIG. 11 shows the results of the measurement. From the result it is apparent that the produced MgB₂ superconductive wire is a good superconductive wire rod showing magnetic field dependency.

### Example 2:

Production of Double Metal Tube having Metal Film capable of being alloyed with both Metals

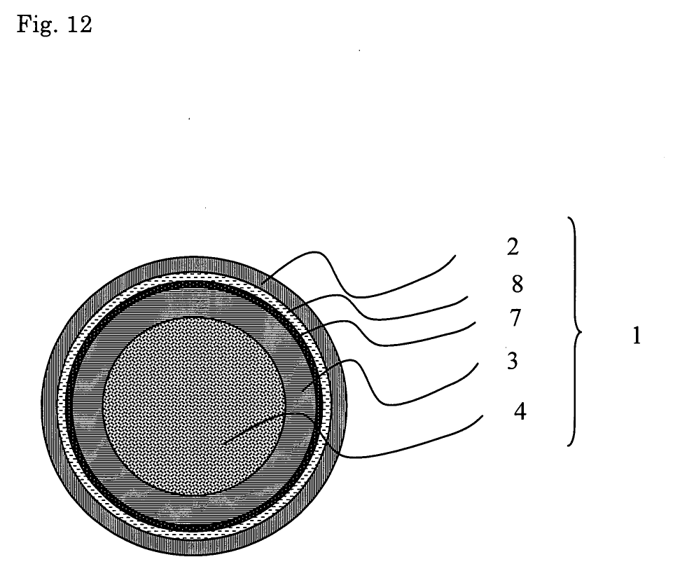

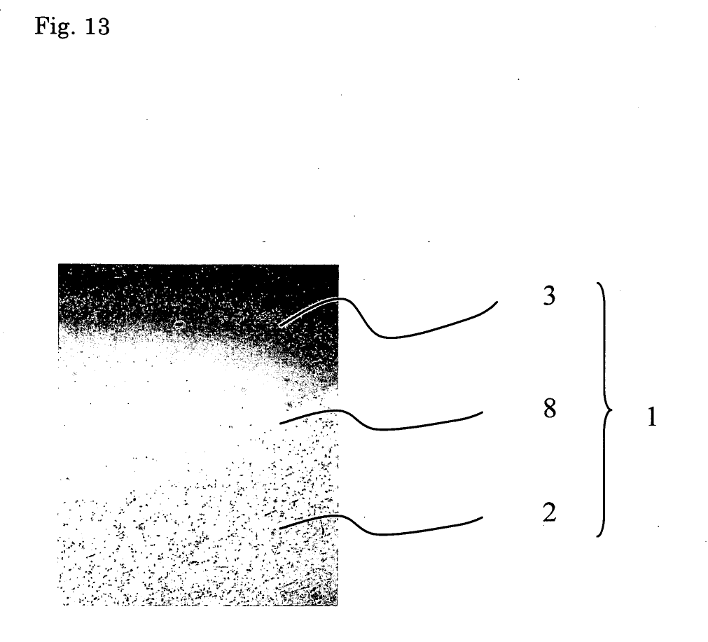

A double metal tube was produced by using a metal film capable of being alloyed with an inner metal tube and an outer metal tube. Fe was used in the inner metal tube and Cu was used in the outer metal tube. FIG. 12 shows the cross section structure of an MgB₂ superconductive wire which was produced in this example. The MgB₂ superconductive wire 1 was constituted of an outer metal tube 2, a metal film 8, a metal-added layer 7, an inner metal tube 3, and an MgB₂ core portion 4. In this case, the outer metal tube 2 was a Cu tube, the metal film 8 was an Ni film, the metal-added layer 7 was a Ti-added layer, and the inner metal tube 3 was an Fe tube. Under the same conditions as in Example 1-1, the removal of an oxidized layer by Ti and the formation of the metal-added layer were performed on the Fe tube, and an Ni film was formed on the metal-added layer. Next, an Mg powder and a B powder, which had been mixed in a ball mill, were filled in this Fe tube in Ar gas atmosphere on which the Ni film had been formed. The Fe tube was then covered with the Cu tube, and drawing wire was performed by using a draw bench. FIG. 13 shows a cross section photograph of the MgB₂ superconductive wire produced in this example. As a result of an observation of the cross section surface of the MgB₂ superconductive wire, it became apparent that the bond at an interface between Cu and Fe wherein Ni is interposed is uniform and good. From the foregoing it is apparent that a similar effect is obtained also by forming a film of a metal metallurgically capable of being alloyed with both metals of the inner metal tube and the outer metal tube.

### Example 3:

Production of Double Metal Tube having highly Adhesive Layer

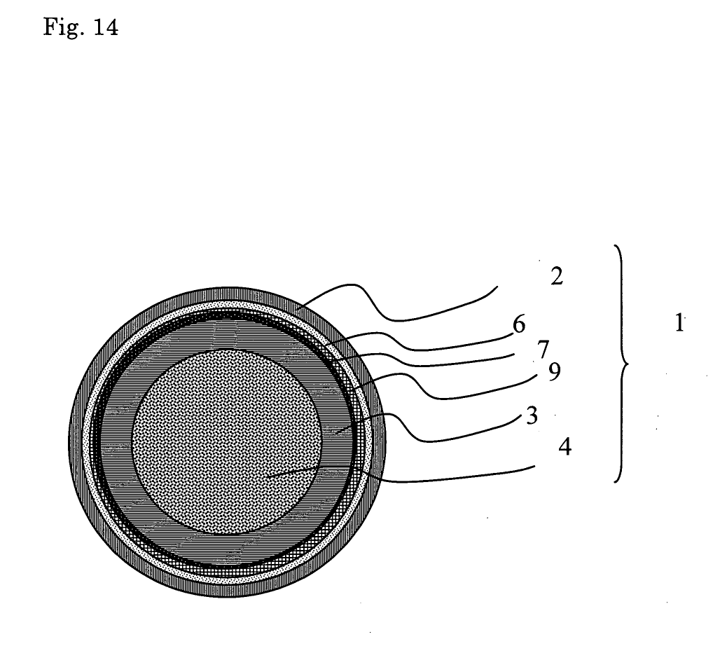

A double metal tube was produced by forming a highly adhesive layer between a metal-added layer and a metal film. FIG. 14 shows the cross section structure of an MgB₂ superconductive wire having a film of a multistage structure. The MgB₂ superconductive wire 1 was constituted of an outer metal tube 2, a metal film 6, a highly adhesive layer 9, a metal-added layer 7, an inner metal tube 3, and an MgB₂ core portion 4. In this case, the outer metal tube 2 was a Cu tube, the metal film 6 was a Cu film, the highly adhesive layer 9 was an Ni film, the metal-added layer 7 was a Ti-added layer, and the inner metal tube 3 was an Fe tube. An MgB₂ superconductive wire was produced by using this structure. As a result of an observation of the cross section surface, the bond at an interface between Cu and Fe wherein Ni is interposed was uniform and good. From the foregoing it is apparent that a similar effect is obtained also in a case where the highly adhesive layer is formed between the metal-added layer and the metal film.

### Example 4:

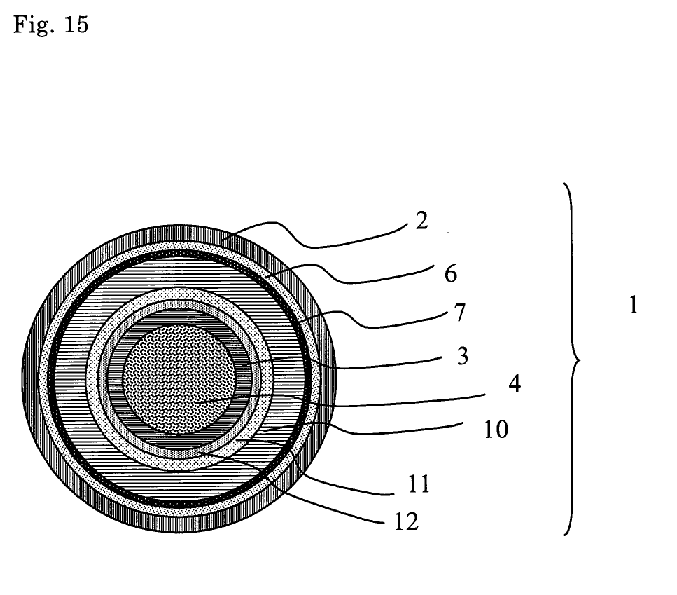

Production of Triple Metal Tube FIG. 15 shows the cross section structure of an MgB₂ superconductive wire having a triple-tube structure, which was produced in this example. The MgB₂ superconductive wire 1 was constituted of an outer metal tube 2, a metal film 6, a metal-added layer 7, an intermediate metal tube 10, an innermost metal film 11, an innermost metal-added layer 12, an inner metal tube 3, and an MgB₂ core portion 4. In this case, the outermost metal tube 2 was a Cu tube, the metal film 6 was a Cu film, the metal-added layer 7 was a Ti-added layer, the intermediate metal tube 10 was an Al tube, the innermost metal film 11 was Al, the innermost metal-added layer 12 was a Ti-added layer, and the inner metal tube 3 was an Fe tube. An MgB₂ superconductive wire having this structure was produced in a manner similar to the above-described example. As a result of an observation of the cross section structure, it is apparent that bonds at interfaces between Cu and Al and between Al and Fe are uniform and good. From the foregoing it is apparent that a similar effect is obtained also in the case of a multi-layered tube structure.

### Example 5:

Bonding of Metal Bar and Metal Tube

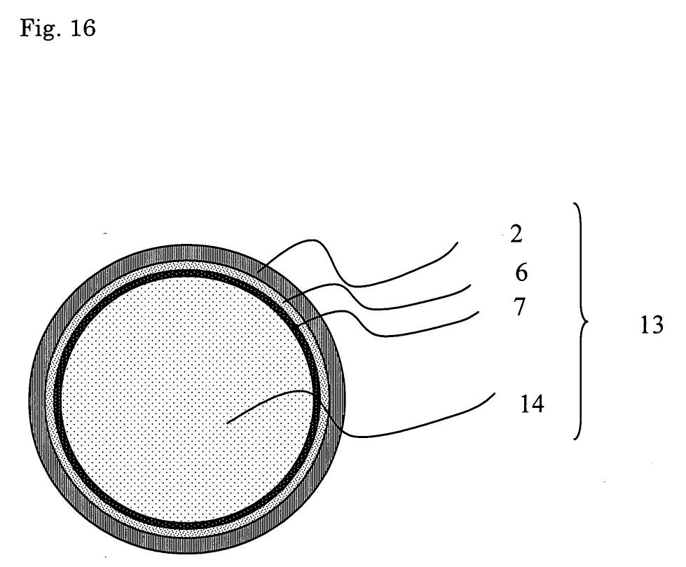

A double metal tube in which center part was a metal bar was produced by the same method as in Example 1. FIG. 16 shows the cross section structure of a double metal tube which was produced in this example. The double metal tube 13 was constituted of an outer metal tube 2, a metal film 6, a metal-added layer 7, and an inner metal bar 14. In this case, the outer metal tube 2 was a Cu tube, the metal film 6 was a Cu film, the metal-added layer 7 was a Ti-added layer, and the inner metal bar 14 was an Fe—Ni bar. By irradiating the Fe—Ni metal bar with Ti ions, an oxidized layer was removed and the metal-added layer was formed, and then the Cu film was formed, and on which Cu tube was covered, and drawing wire by a draw bench was performed. As s result of an observation of the cross section surface, it is apparent that the interface between Cu and Fe—Ni is uniform and good. From the foregoing, it is apparent that a similar effect is obtained also in a case where a metal bar is used in place of an inner metal tube.

### Example 6:

Metal Plate

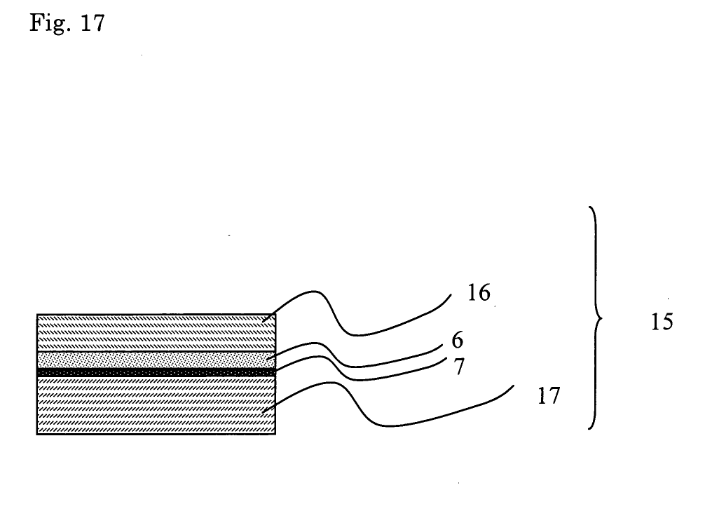

A double metal plate was produced by using a method similar to those in Examples 1 and 2. FIG. 17 shows the cross section structure of the double metal plate which was produced in this example. The double metal plate 15 was constituted of an upper metal plate 16, a metal film 6, a metal-added layer 7, and a lower metal plate 17. In this example, the upper metal plate 16 was made of Al, the metal film 6 was an Al film, the metal-added layer 7 was a Ti-added layer, and the lower metal plate 17 was made of Cu. By irradiating the Cu metal plate with Ti ions, an oxidized layer was removed and the metal-added layer was formed, and after that, the Al film was formed. And rolling was performed, with the Al plate placed on top of the Al film. As a result of an observation of the cross section surface, it is apparent that a bond at an interface between Cu and Al is uniform and good. From the foregoing it is apparent that a similar effect is obtained also in bonding of metal plates.

The present invention can be used in superconductive wire rods, which are applied to electric current leads, power cables, large magnets, and equipment, such as a nuclear magnetic resonance spectrometer, a magnetic resonance diagnostic device for medical use, a superconductive power storage device, a magnetic separator, a magnetic field applied single-crystal pulling device, a cooling superconductive magnet device for refrigerator, a superconductive energy storage device, a superconductive generator, and a magnet for nuclear fusion reactor, clad metals in which dissimilar metals are bonded, DUMET wires applied to electric bulb filaments, and the like.

All publications, patents, and patent applications cited herein are incorporated herein by reference in their entirety.

What is claimed is:

1. A method of bonding metal surfaces together, comprising the steps of:
forming a metal-added layer on one metal surface;
forming a metal film, which is made of a metal of the same kind as the other metal surface or a metal capable of being alloyed with the other metal surface, as a layer above the metal-added layer; and
performing large deformation, with the other metal surface brought into close contact with the metal film.

2. A method of bonding an inner metal tube or an inner metal bar and an outer metal tube, comprising the steps of:
forming a metal-added layer on an outer circumferential surface of the inner metal tube or the inner metal bar;
forming a metal film, which is made of a metal of the same kind as the outer metal tube or a metal capable of being alloyed with the outer metal tube, as a layer outward from the metal-added layer; and
performing area-reducing processing.

3. A method of bonding an inner metal tube or an inner metal bar and an outer metal tube, comprising the steps of:
forming a metal-added layer on an inner circumferential surface of the outer metal tube;
forming a metal film, which is made of a metal of the same kind as the inner metal tube or the inner metal bar or a metal capable of being alloyed with the inner metal tube or the inner metal bar, as a layer inward from the metal-added layer; and
performing area-reducing processing.

4. A method of bonding metal surfaces of metal plates together, comprising the steps of:
forming a metal-added layer on a surface of one metal plate;
forming a metal film, which is made of a metal of the same kind as the other metal plate or a metal capable of being alloyed with the other metal plate, as a layer above the metal-added layer; and
performing rolling, with the other metal plate brought into close contact with the metal film.

5. The method according to any one of claims 1 to 4, wherein the metal-added layer contains a metal selected from the group consisting of Ti, Cr, TiAl, C, Al, V, Fe, Co, Ni, Cu, Zr, Nb, Mo, Ag, Hf, Ta and W.

6. The method according to any one of claims 1 to 4, wherein the film thickness of the metal film is 0.01 μm to 100 μm.

7. The method according to any one of claims 1 to 4, wherein the metal film is formed under the conditions of 10⁻¹ Pa to 10⁻¹⁰ Pa and 150° C. to 600° C.

8. A multi-layered metal tube which is obtained by the method according to claim 2 or 3, and has a structure in which the inner metal tube or the inner metal bar and the outer metal tube are bonded.

9. A multi-layered metal tube having a structure in which an inner metal tube or an inner metal bar and an outer metal tube are bonded, comprising:
an inner metal tube or an inner metal bar;
a metal-added layer formed on an outer circumferential surface of the inner metal tube or the inner metal bar;
a metal film which is formed as a layer outward from the metal-added layer and made of a metal of the same kind as the outer metal tube or a metal capable of being alloyed with the outer metal tube; and
an outer metal tube which is bonded to the inner metal tube or the inner metal bar via the metal-added layer and the metal film.

10. A multi-layered metal tube having a structure in which an inner metal tube or an inner metal bar and an outer metal tube are bonded, comprising:
the outer metal tube;
a metal-added layer formed on an inner circumferential surface of the outer metal tube;
a metal film which is formed as a layer inward from the metal-added layer and made of a metal of the same kind as the inner metal tube or the inner metal bar or a metal capable of being alloyed with the inner metal tube or the inner metal bar; and
the inner metal tube or the inner metal bar which is bonded to the outer metal tube via the metal-added layer and the metal film.

11. The multi-layered metal tube according to claim 9 or 10, wherein the metal-added layer contains a metal selected from the group consisting of Ti, Cr, TiAl, C, Al, V, Fe, Co, Ni, Cu, Zr, Nb, Mo, Ag, Hf, Ta and W.

12. The multi-layered metal tube according to claim 9 or 10, wherein the film thickness of the metal film is 0.01 μm to 100 μm.

13. A multi-layered metal plate which is obtained by the method according to claim 4 and has a structure in which multiple metal plates are bonded.

14. A multi-layered metal plate in which multiple metal plates are bonded, comprising:
a metal plate;
a metal-added layer formed on a surface of the metal plate;
a metal film formed as a layer above the metal-added layer; and
an additional metal plate bonded to the metal plate via the metal-added layer and the metal film,
wherein the metal film is made of a metal of the same kind as the additional metal plate, which is bonded to the metal plate via the metal-added layer and the metal film, or is made of a metal capable of being alloyed with the additional metal plate.

15. The multi-layered metal plate according to claim 14, wherein the metal-added layer contains a metal selected from the group consisting of Ti, Cr, TiAl, C, Al, V, Fe, Co, Ni, Cu, Zr, Nb, Mo, Ag, Hf, Ta and W.

16. The multi-layered metal plate according to claim 14, wherein the film thickness of the metal film is 0.01 μm to 100 μm.
